(19) United States
(12) Patent Application Publication
(10) Pub. No.: US 2017/0108929 A1
(43) Pub. Date: Apr. 20, 2017

(54) System and Method for Full Motion Capture and Haptic Feedback Suite

(71) Applicants: Morgan Walker Sinko, Rochester, NY (US); Lucian James Copeland, Rochester, NY (US); Jordan Brooks, Rochester, NY (US); Gary Ge, Rochester, NY (US); Christian Frietas, Rochester, NY (US); Casey Waldren, Rochester, NY (US); Kian Jones, Rochester, NY (US); Alexander James Matthers, Rochester, NY (US)

(72) Inventors: Morgan Walker Sinko, Rochester, NY (US); Lucian James Copeland, Rochester, NY (US); Jordan Brooks, Rochester, NY (US); Gary Ge, Rochester, NY (US); Christian Frietas, Rochester, NY (US); Casey Waldren, Rochester, NY (US); Kian Jones, Rochester, NY (US); Alexander James Matthers, Rochester, NY (US)

(21) Appl. No.: 15/141,564

(22) Filed: Apr. 28, 2016

Related U.S. Application Data
(60) Provisional application No. 62/154,068, filed on Apr. 28, 2015.

(51) Int. Cl. G06F 3/01; G06T 7/20

(52) U.S. Cl. CPC G06F 3/016; G06F 3/011; G06T 7/20; G06T 19/006

(57) ABSTRACT

A full motion capture and haptic feedback suite which allows users to touch and feel virtual objects used with a KINECT or made into a hybrid state using 9-axis sensors to move freely outside the view of the KINECT. The suite uses a combined software and hardware platform for immersive virtual reality, capable of tracking a user's movements, translating them into a virtual space, and providing haptic feedback when the user comes into contact with a virtual object. Essentially, this allows a user to “feel” the object, adding another level of sensation on top of the visual feedback provided by a television or a headset. The system uses a KINECT and an integrated sensor network to detect the user's position in a space without the traditional limits of a consumer motion capture system. It then sends touch feedback to a custom-designed feedback suit based on virtual interactions.

### CROSS REFERENCE TO RELATED APPLICATIONS

This application claims priority from U.S. Patent Application Ser. 62/154,068, entitled “System and Method for Full Motion Capture and Haptic Feedback Suite”, filed on 28 Apr. 2015. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to touch feedback and virtual reality. More specifically, the present invention is a platform for adding haptic feedback and high resolution tracking to virtual reality systems.

### BACKGROUND OF THE INVENTION

The market for virtual reality is currently in a phase of extremely rapid growth and development. Within the past two years, the market for virtual reality (VR) headsets has gone from a singular released product, the OCULUS RIFT, to headset releases from virtually every major player in the gaming industry and beyond. Accompanying the rapid development of headset electronics is a surge of interest in VR peripherals to aid in improving the tracking, immersiveness, and control fidelity of VR interfaces. While no VR products have yet entered the market as consumer releases, early adopter interest has been strong with several public crowd funding events raising in the millions of dollars. Several established VR companies have seen high value acquisitions on the order of several billion dollars. While several other minor haptics-capable products have entered development, the haptics and full-body tracking market for virtual experiences remains severely underdeveloped.

According to analyses released by market research aggregates NewZoo and Gartner Inc., the current size of the gaming industry is between 70 to 90 billion dollars, with the subset of console and PC markets currently capable of supporting virtual reality hardware coming in at an estimated share of 60 billion. Extensive growth for the VR market is expected as more users become comfortable with the quality of existing technology and the fidelity of their experiences. Haptics have seen less impact due to low diversity products and failed marketing plans.

### DEFINITIONS

Unless stated to the contrary, for the purposes of the present disclosure, the following terms shall have the following definitions:

“Accessibility” refers to two separate attributes—accessibility by consumers and accessibility by developers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other. A good API makes it easier to develop a program by providing all the building blocks. A programmer then puts the blocks together. In addition to accessing databases or computer hardware, such as hard disk drives or video cards, an API can ease the work of programming GUI components. For example, an API can facilitate integration of new features into existing applications (a so-called “plug-in API”). An API can also assist otherwise distinct applications with sharing data, which can help to integrate and enhance the functionalities of the applications. APIs often come in the form of a library that includes specifications for routines, data structures, object classes, and variables. In other cases, notably SOAP and REST services, an API is simply a specification of remote calls exposed to the API consumers. An API specification can take many forms, including an International Standard, such as POSIX, vendor documentation, such as the Microsoft Windows API, or the libraries of a programming language, e.g., Standard Template Library in C++ or Java API.

“API Toolkit” A toolkit is an assembly of tools; set of basic building units for user interfaces. An “API Toolkit” is therefore a set of basic building units for creating an application programming interface (API).

For the purposes of a virtual reality wearable technology, the term “ease of use” encompasses comfort and reliability.

“Fidelity”, at its most basic level, refers to the ability of the system to create an accurate tactile depiction of a virtual environment.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

A “module” in software is a part of a program. Programs are composed of one or more independently developed modules that are not combined until the program is linked. A single module can contain one or several routines or steps.

A “module” in hardware, is a self-contained component.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “User” is any person using the computer system executing the method of the present invention.

### SUMMARY OF THE INVENTION

The present invention is a full motion capture and haptic feedback suite which allows users to touch and feel virtual objects. The present invention can be used with a KINECT or made into a hybrid state using 9-axis sensors to move freely outside the view of the KINECT.

The present invention uses a combined software and hardware platform for immersive virtual reality, capable of tracking a user's movements, translating them into a virtual space, and providing haptic feedback when the user comes into contact with a virtual object. Essentially, this allows a user to “feel” the object, adding another level of sensation on top of the visual feedback provided by a television or a headset such as the OCULUS RIFT.

The system uses a KINECT and an integrated sensor network to detect the user's position in a space without the traditional limits of a consumer motion capture system. It then sends touch feedback to a custom-designed feedback suit based on virtual interactions. A software development kit is also being created for hybrid motion tracking, feedback management, and application development for use by independent content creators. The combined product suite can be used for game development, simulation, and a variety of industry, medical, and research applications.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 illustrates a hand cluster, with each of the motors encased in blue representing one zone.

FIGS. 2-3 illustrate the PCB assembly used at the hands.

FIGS. 4-5 illustrated the schematics used for the left hand driver system, following standard designs for discrete-component motor drivers.

FIGS. 6-8 are images of the 3D designs used the motor casings and back electronics casing.

FIG. 9 illustrates an embodiment of the present invention using gloves, a jacket, and an ocular system.

FIGS. 10-11 illustrate the PCB assembly used at the hands.

FIG. 12 illustrates the several embodiments of the present invention ranging from the least sophisticated system only using the gloves, to the most sophisticated embodiment using gloves, and a jacket with a high density of sensors and haptic feedback motors and an ocular system.

FIG. 13 illustrates a system sketch of one embodiment of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

As gaming and real time simulation become more common, fast reaction speeds and immersive experiences are rapidly becoming more important in technological peripherals. While carefully engineered controllers or sensitive motion tracking can smooth the translation of user commands into a virtual interface, they cannot provide any kind of useful feedback on whether those commands have been executed successfully. Even sophisticated VR systems like the Oculus Rift can only provide visual feedback, and will not respond physically when the player interacts with a virtual environment.

This disconnect between visual input and kinematic sensation can be disorienting, and thus systems like the Kinect and the Oculus can be described as having an “uncanny valley” of spatial experience, where users feel they are close to having a fully immersive experience but are thrown off by the absence of peripheral sensation. Attempts at physical interactions can be difficult or even frustrating when there is no feedback associated with them, forming a major limitation for entertainment products or simulation environments that rely on such interactions.

The present invention is a combined software and hardware platform for immersive virtual reality, capable of tracking a user's movements, translating them into a virtual space, and providing haptic feedback when the user comes into contact with a virtual object. Essentially, this allows a user to “feel” the object, adding another level of sensation on top of the visual feedback provided by a television or a headset such as the OCULUS RIFT. The system uses a KINECT and an integrated sensor network to detect the user's position in a space without the traditional limits of a consumer motion capture system. It then sends touch feedback to a custom-designed feedback suit based on virtual interactions. A software development kit is also being created for hybrid motion tracking, feedback management, and application development for use by independent content creators. The combined product suite can be used for game development, simulation, and a variety of industry, medical, and research applications.

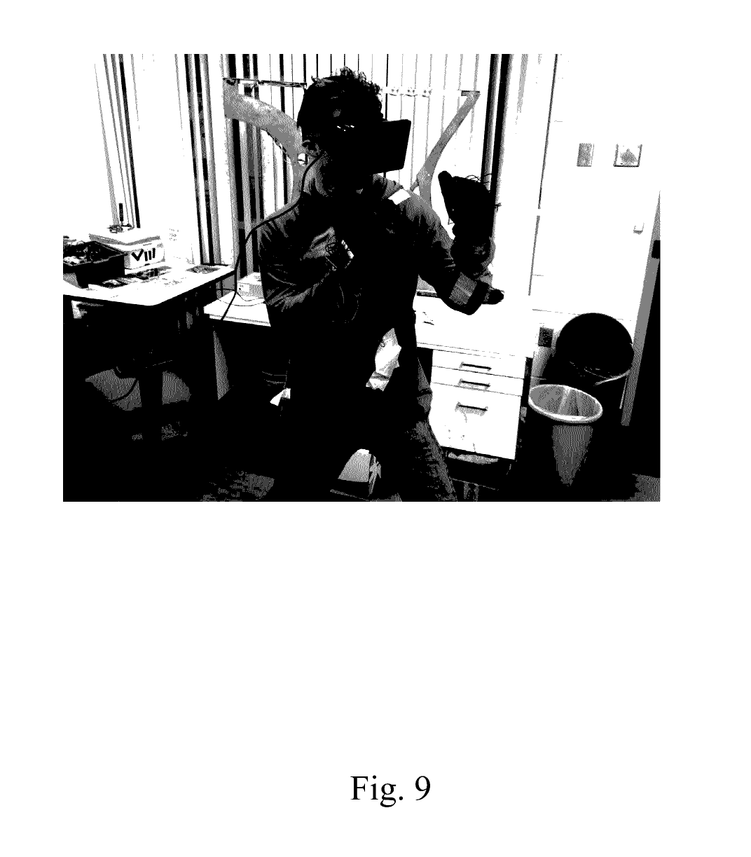

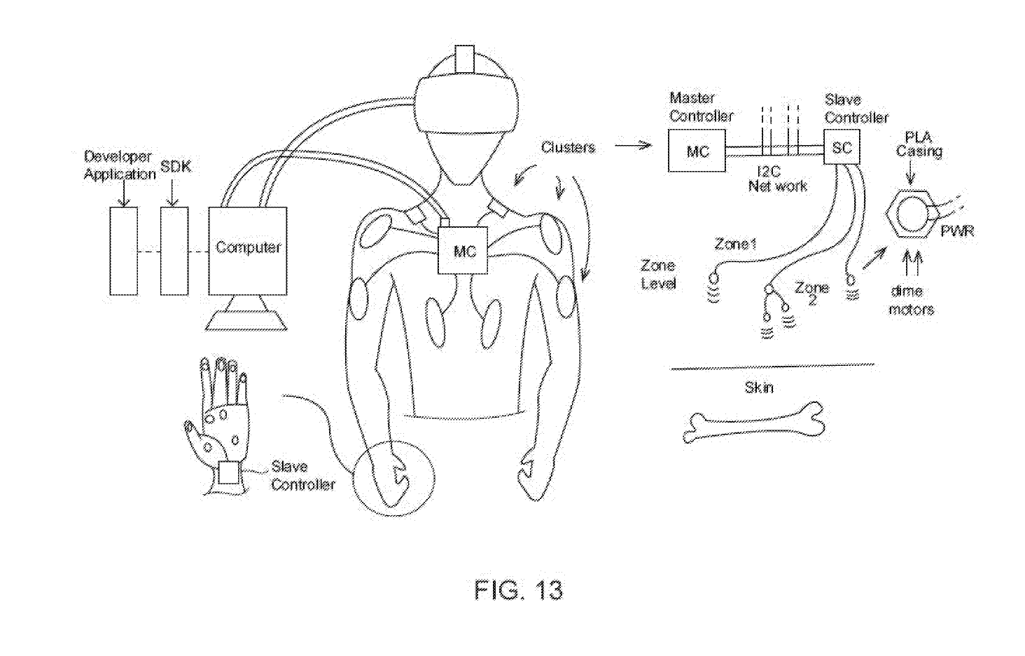

In one embodiment of the present invention, the system is defined by a full-body suit embedded with vibrating motors and sensors, allowing users to “feel” virtual objects that have been projected around them by triggering specific feedback pads placed on the body as shown in FIG. 9. A system sketch is shown in FIG. 13, that illustrates the components of the present invention which include the developer application, SDIC, Computer, Slave Controller, MC, Clusters, Master Controller, I2C Network, Slave Controller, Zone levels, Casings, and drive motors.

Alternative embodiments include a stripped down hands-only version intended for desktop use, and a larger cloth-free exoskeleton embodiment intended for applications where sanitation and a one-size-fits-all design are desirable.

All embodiments are intended for use with a 3D tracking system such as the XBOX KINECT or LEAPMOTION devices, and contain an array of any combination of gyroscope, acclerometer, and magnetometer-based tracking sensors capable of compensating for camera obstructions and out of range motion, allowing for a seamless tracking experience on the part of the user.

The present invention offers a number of advantages when compared to other haptic feedback products or non-haptic VR. The present invention's suits are full body, and allow both finger-level tracking resolution and full-body tracking for wide spaces while walking freely, a feature not available in any other product on the market. The embedded vibration system is less intrusive and of a higher quality than other comparable products, and is able to provide a wide range of variable sensations through a sophisticated waveform driver system.

The present invention teaches an entirely novel approach to the problems of camera occlusion and offers an unparalleled stability for cost when compared to traditional capture systems. The system is intentionally minimalistic in size, with breathable fabric and low-weight materials for emphasized consumer comfort. In addition, no other haptics product has been marketed specifically for the VR market, with the intention of supporting athletic playstyles, intentional object interaction (as opposed to passive environmental cues), and full-body feedback for virtual collisions.

Fidelity, at its most basic level, refers to the ability of the system to create an accurate tactile depiction of a virtual environment. The present invention has focused on five strategies for increasing fidelity. The first, lowering latency, has been accomplished through the use of high-speed I2C serial networks as data links between parts of the body. This network limits the time data takes to travel to the feedback hardware to well under the human perception limit of 15-20 ms.

High tracking resolution and low tracking error also play major roles in increasing system fidelity. By incorporating the higher resolution available with the MICROSOFT KINECT v2 and utilizing the LEAP Motion sensor for specific applications requiring even finer finger tracking, the present invention has increased its resolution significantly. Together with an integration algorithm that combines data from the KINECT with data from an on-suit gyro-accelerometer sensor network, the system provides a consistent high-resolution tracking solution complete with occlusion compensation and an expansive range.

For the purposes of a virtual reality wearable technology, the term “ease of use” encompasses comfort and reliability. The suit of the present invention is comfortable and easy to put on, with a zipper on the jacket and two simple plugs on the hands (which will be replaced by wireless communication in future iterations of the hardware) as shown in FIG. 9. The new suit takes approximately half as much time to put on and take off as the old one. The system has been designed from the ground up to be robust and reliable, able to stand up to the rigors of active use without danger of failing. Protective casings have been created for the delicate motors, as well as the circuitry on the back of the suit.

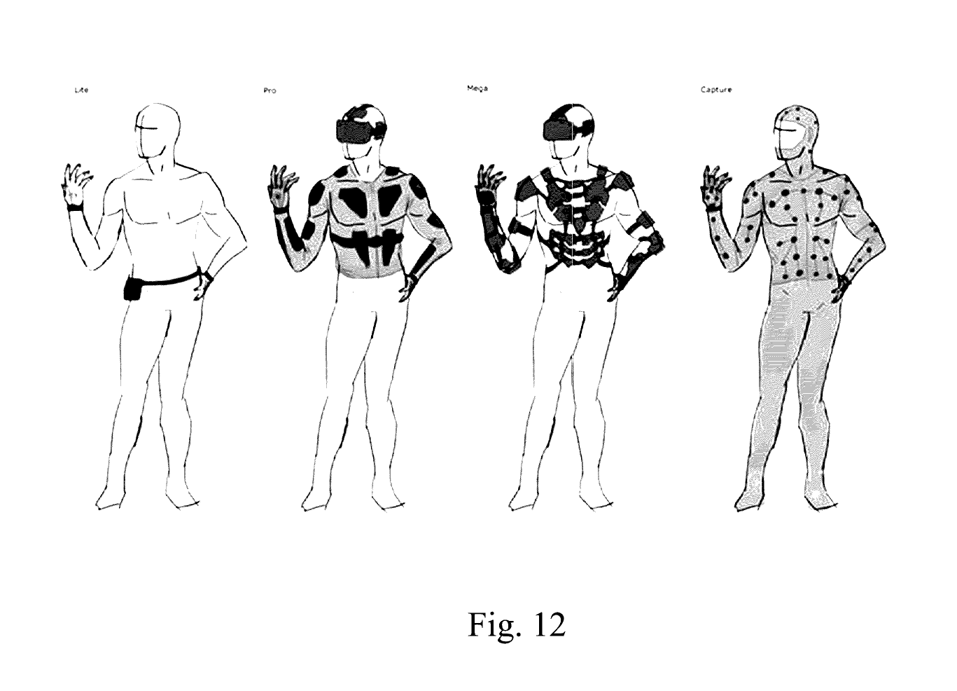

FIG. 12 illustrates possible product concepts and various embodiments of the present invention with respect to a “lite” version which only uses the hand/glove technology, a pro version that uses a body suit/jacket in combination with the hands/gloves and an ocular component. A “mega” and “capture” versions respectively show an increased use in sensors and motors for providing haptic feedback with the “capture” version having the highest density of components.

Of course, none of the advances in tracking have much effect without the ability to provide feedback at the same resolution. To this end, the VR feedback hardware consists of thirty feedback zones, each capable of individual analog control, providing various levels of clicks, hums, buzzes, and other sensations. Spaced out over the entire upper body, the zones have higher feedback coverage and resolution than any other available product as shown in the system sketch of FIG. 13.

Overall, the system of the present invention delivers an unprecedented level of fidelity by reducing latency below perceptible levels, increasing both tracking and feedback resolution beyond any other consumer products on the market, and compensating for occlusion and other tracking errors.

During original testing and preparation of the system, the vibration actuators were meant to be in direct skin contact with the user. However tests with several subjects have shown that this is invariably uncomfortable. In response to this, tests were done to gauge the level of sensation given from indirect contact. This included sensation across 1-5 layers of fabric, and across hard surfaces such as metal, rubber, and plastic. The results showed to be promising and as such allowed us to increase wearer comfort greatly by placing the vibration actuators on an exterior layer of the fabric.

In selecting materials and components for the suit itself, the inventors have focused on keeping production costs low. Custom printed circuit boards will also allow consumer production costs to be well below the initial development costs.

The three versions of the hardware, referred to as CORESPACE, PROSPACE, and REALSPACE, have been developed to be as accessible as possible to each intended market. The CORESPACE, the general consumer model, is the most comfortable and easiest to use. The PROSPACE, focused on research, medicine, and professional simulation, is more flexible, allowing a larger range of users and more developer hardware access. The REALSPACE, intended for professional and creative users, mostly in CAD-related fields, is a stripped-down version of the system, making it more affordable while retaining and even enhancing the components necessary for its users (especially hand tracking and feedback resolution).

The system of the present invention relies on two computer systems: the ARDUINO system and the UNITY PC game engine. The UNITY game engine is used by 47% of game developers, and for good reason. UNITY provides a sophisticated physics engine for collision detection, high quality graphics and rendering and the ability to easily deploy too many different platforms, such as WINDOWS, MACINTOSH, LINUX and ANDROID. Unity facilitates a rapid iterative development process, giving the ability to rapidly test and modify the demos and API. Currently the present invention's API is written in C#, with plans to include C++ in the future.

The present invention originally relied on CMU's Unity Kinect wrapper for tracking and displaying the avatar. This wrapper worked for the Kinect 1 and displayed a joint-based point representation of a person (PointMan). Although fast and simple, PointMan was somewhat disconcerting and immersion-breaking because he looked nothing like a person. For example, when a user would look down at their hands, they would see two red spheres indistinguishable from the other red spheres representing all of their other body parts.

To overcome this, the Inventors made the transition to Microsoft's official Kinect 2 Unity package in 2015. This package would render another incarnation of the PointMan, but included the ability to track if the user's hands are opened or closed fairly reliably. Efforts to rig and skin a human model for use with the Kinect 2 were ultimately unsuccessful.

One of the problems that must be dealt with when using a motion tracking system like the Kinect is that joint positions and rotations are often reported, while traditional 3D models use bones. If a joint was directly parented to the relevant area in a mesh, then the mesh would deform horribly whenever the user moved. Instead, some form of inverse or forward kinematics is needed.

Creating a 3D model with the correct bone structure for the Kinect proved difficult. Blender, a 3D modeling package, seemed to be exporting incorrect bone orientations, or Unity was importing them and making incorrect assumptions. When using Kinect data to manipulate models, some portions of the model would be wildly incorrect while others would be correct. Getting this working is peripheral to the goals of the Inventors, so research was conducted to find a better solution.

RUIS (Reality-based User Interface System) fixed some of the previous problems and allowed for forward progress. RUIS is a Unity project which aims to give developers easy access to many motion control and tracking systems while providing a system to implement the virtual world. This system includes virtual menus, calibration routines, 3D avatars, gesture recognition, and more. RUIS supports the Kinect 1 and Kinect 2, as well as the Oculus DK1 and DK2.

RUIS provides the avatar for the current devices used by the present invention. This avatar has the capability to be controlled in part by Mecanim, Unity's animation technology. This way, animated walking can be blended with upper-body Kinect control of the skeleton, which is useful if a user is sitting. RUIS also provides a calibration routine which allows the Kinect 2 to recognize the floor and place the avatar correctly on top of it. RUIS is also robust; a Kinect can be plugged in during a demo or a user can walk away, and the skeleton will still be acquired after a short delay. Compared to the Kinect 1 with the CMU wrapper, this is a significant improvement.

In UNITY, the present invention's demo environment consists of interaction-enabled objects. These are the punching bag, wind chimes, and scanners. The punching bag is a 3D model connected to a hinge joint so it can rotate in 3D space. Punching it will trigger haptic responses in the hands. The wind chimes are a series of box colliders which can be swept through with a hand or arm in order to trigger haptic responses. The use of scanners provides textured planes that are able to move back and forth over a user. Their purpose is to trigger a wave of haptic responses in the direction they are moving. In the demo, they can be activated by punching a box near the user's head, or by simply walking through them.

In a DodgeBlocks demo, the environment is a plane to stand on along with multiple box colliders to interact with. The player stands on one side of a plane, and boxes fly towards the player at varying speeds. The player's goal is to move around and duck to evade the incoming blocks. Being hit by a block will trigger a haptic response at the impact zone of the block.

The present inventions LEAPMOTION demo uses the LEAPMOTION's fine-grained finger tracking to allow the player to pick up blocks and receive a haptic response simulating the feeling of holding an actual block.

OCULUS integration is an important part of the present invention. Luckily RUIS supports both the DK1 and DK2. There is also an embodiment of the present invention that uses a 3rd person camera instead of the OCULUS. This is good for people who do not want the hassle of putting on an OCULUS, for people who get motion sickness, or for people who just want to experience the haptics. Although OCULUS adds immersion to the experience, 3rd person mode is also immersive and functions fine without the added peripheral.

The present invention's API is designed to be simple to use. Currently the API is essentially a serial communications wrapper for UNITY.

There are three required files to use the API, and a simple procedure to setting them up. First, a gameobject must be created to host HTFeedback and HTSerialHandler. Then a script must be created by the developer, which will instantiate HTFeedback and pass commands to it. This can be implemented in any way the developer wants. One way is to attach a script (now referred to as CollisionScript) to the same empty gameobject and using Unity's broadcast system to pass around collision events.

For example, each object that should trigger a haptic response when touched would have a script attached to it. This script would simply re-broadcast collision events to the CollisionScript, which would then figure out which commands to send to HTFeedback. With a skeleton, it is natural to use a switch statement or a hashtable to determine which collision zones on an in-game character should correspond to which haptic zones on the suit. One might associate a character's left hand with the haptic zone for left hand, or one might associate it with multiple zones.

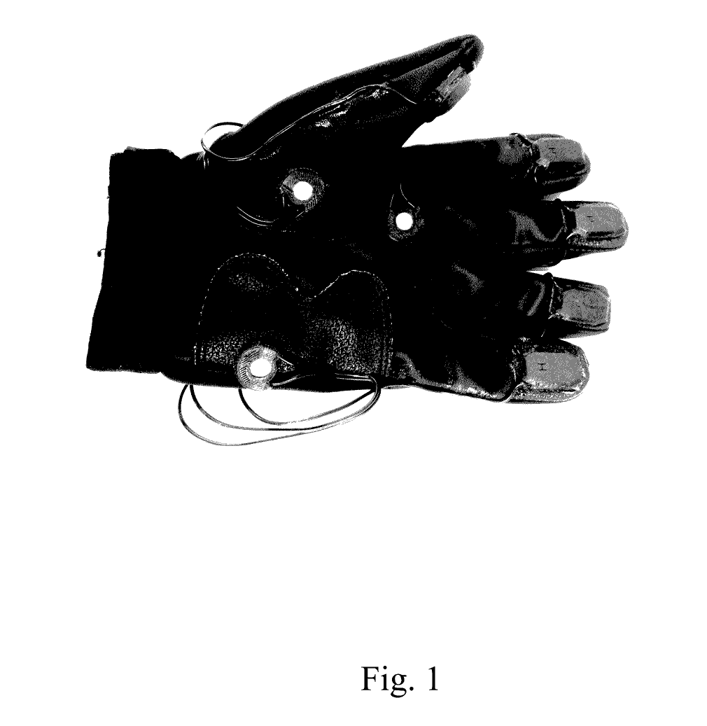

The present invention refers to haptic Clusters and haptic Zones. These concepts are mirrored in the hardware and the software. In the hardware, a Cluster is a group of Zones. The upper body is a cluster, as is the lower body and each of the two hands. Clusters are logical groupings as well as hardware-limited groupings: currently only eight clusters can exist, each containing up to sixteen zones. Each zone could be one motor or many within one pad: in the hands, each zone is one motor on each fingertip. On the chest, each zone is multiple motors. The highest resolution that a motor can be addressed by is its zone. In other words, a Zone is a motor, or unified group of motors. A Cluster is a logical group of Zones. FIG. 1 illustrates a hand cluster, with each of the motors encased in blue representing one zone.

The basic method to using the present invention is by creating a feedback object and then calling that object's methods. An example is: feedback.setCluster(Cluster cluster).activate(Zone zone);

The setCluster method tells the present invention which cluster should be targeted, while the activate method specifies which zone. All clusters and zones are defined in HTEnums, and are as follows.

### Clusters

Debug=0,

UpperBody

LowerBody

RightHand

LeftHand

### Zones

All=0,

Palm,

Thumb,

Index,

Middle,

Ring,

Pinky,

LeftForeArmTop=0,

LeftForeArmBottom,

LeftUpperArm,

LeftShoulder,

RightShoulder,

RightUpperArm,

RightForeArmBottom,

RightForeArmTop,

Dummy1=0,

LeftChest,

LeftSolar,

LeftStomach,

RightStomach,

RightSolar,

RightChest

The zones increment by one and regularly reset to an integer value of zero which signifies the start of a new cluster. The cluster and zone enums can be used for convenience, but casted integers will work just fine for loops as well. Other methods that can be called in the feedback object are now explained.

void activateAll( ) This will activate every zone in a given cluster. It works by enumerating the total amount of zones in the cluster and then sending the commands to turn them all on.

void deactivateAll( ) This works the same as above, except it turns all the motors off.

void toggleAll( ) This is a commonly used method; it turns on the motors in a cluster if they are off, and turns them off if they are on.

void deactivateWholeBody( ) This loops through every cluster and deactivates all of the zones. It is implemented in terms of deactivate. All internally, and it's easy to see how the simple commands can be built upon each other to create more complex behavior.

void activateWholeBody( ) Identical to the above, except it activates every zone.

void toggleWholeBody( ) Identical to the above, except it individually toggles each zone.

void activate(Zone zone) Activates a single zone.

void deactivate(Zone zone) Deactivates a single zone.

void toggle(Zone zone) Toggles a single zone.

eventQueue This is currently an experimental feature that allows haptic events to be queued up with time delays. To implement the startup routine (a pulse that starts in the chest, flows up and down the arms into the fingers) this feature was needed, so that all of the zones would not be activated simultaneously. The eventqueue periodically pops events out and sends them to HTSerialHandler based on whether or not the current time has passed the specified time delay.

The serial protocol between the computer and onboard microcontroller system is implemented by the script HTSerialHandler. Serial events are sent in packets of one byte each for simplicity and speed, although two-byte packets will soon be implemented in order to allow multi-speed haptic responses.

A packet looks like this: 001 0011 1. The binary digits have been split to represent boundaries of the packet format. The first 3 bits represent the cluster ID. The next 4 bits represent the zone ID. The last bit represents “on” or “off”. Bit masks are used in the Arduino to parse the data, and are used in the API to verify that the data was correctly received (as the Arduino echoes back all of its commands). Cluster ID zero is reserved for debugging purposes and special codes, while the byte 0xFF is reserved as a check to make sure the Arduino is receiving commands and ready to go.

Under the hood, HTSerialHandler receives haptic events into a queue. It periodically purges the entire queue down the serial line whenever it gets a chance. When there is nothing to be sent, it instead reads from the port. This reveals a design decision that may change.

Currently the state of the entire haptic device is stored in a Boolean array. Commands affect this array so commands like toggle work properly. It is possible that this array may not reflect reality: a motor might be stuck on, but look like it is toggling correctly in software. At one point state would only be updated when the Arduino echoed back the command that it received: this way the software state would better reflect reality. This approach may not be the best though, as there is a delay between writing and reading. It would be possible for an “on” haptic event to be sent multiple times before the confirmation would be received, all while the user was expecting it to be alternating between on and off. The pros and cons of this approach will be explored soon and it is quite possible that both will be offered as alternatives.

A Master Controller provides commands that sent from the host computer are interpreted by an on-body master controller system, typically implemented as an INTEL GALILEO board or ARDUINO MEGA ADK, which parses the information into on-chip memory and interprets the destination for the in-suit integrated network. Once the serial byte has been masked into different integers referencing cluster, zone, and status, they are run through a case statement that determines the task of the master system as shown in FIG. 13.

Information is distributed through the suit via a combination of direct Pulse-Width-Modulation (PWM) control to the motor drivers, and a single-bus serial I2C network with a master-slave addressing system. Clusters one and two, representing the body, are implemented directly through master IO, as described in the Hardware IO section. Sections three and four, representing the hands, are handled through the I2C bus.

The Inter-Integrated Circuit (I2C) serial network protocol was created by PHILIPS in 1982 as a means of transferring information in circuitry using a simple two-wire bus. While still a proprietary technology, I2C no longer requires licensing fees to use, though some companies such as Arduino utilize the name TWI (Two Wire Interface) to refer to I2C compatible technologies to avoid infringement. It is primarily used for connecting low speed components in integrated or embedded systems. The present invention can use the I2C system or replace that specific component with any serial protocol.

I2C is distinguished from other serial protocols such as SPI or RS232 by the following qualities: Only two bus lines for communication, Serial Clock (SCL) and Serial Data (SDA); Half duplex communication (information is only sent one way at a time); Master-Slave bus node relationship; Addressed slave nodes; Broadcast mode options for activating all slave simultaneously; Pull up resistors on all lines, allowing low-power slave operation; Clock stretching of the SCL line to delay master actions; and Relatively low speeds at around 100 kbits/sec, though higher speeds are available with some devices.

I2C is an ideal network type for the present invention's application for a number of reasons. An emphasis on minimal cabling is preferred, while network speeds are non-critical due to the relatively slow pace of human reaction times. Addressable slave nodes mean that the system is fully expandable to practically any number of slaves without modification to the suit's fundamental cable structure. And low power slave operation allows for the microelectronics managing hand-based clusters to be small and indiscrete.

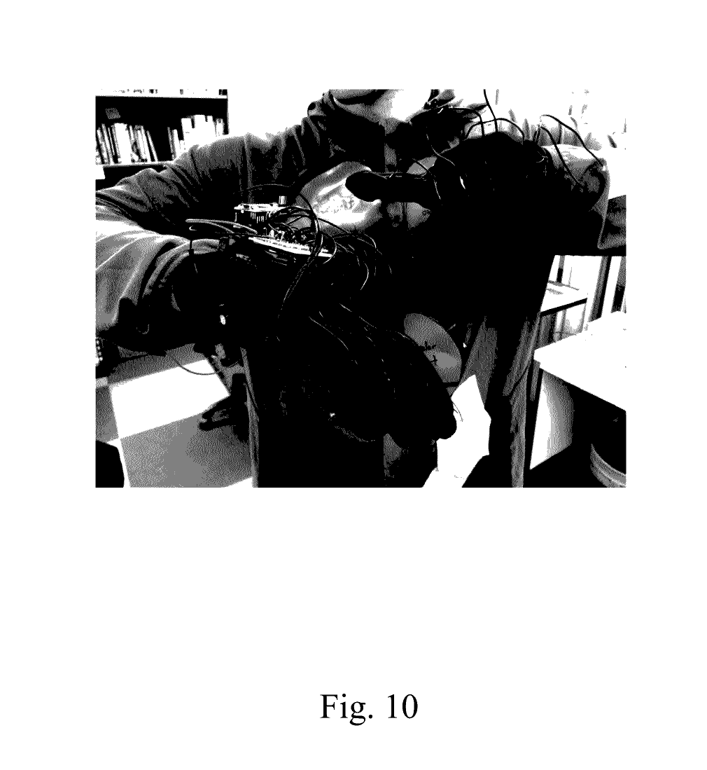

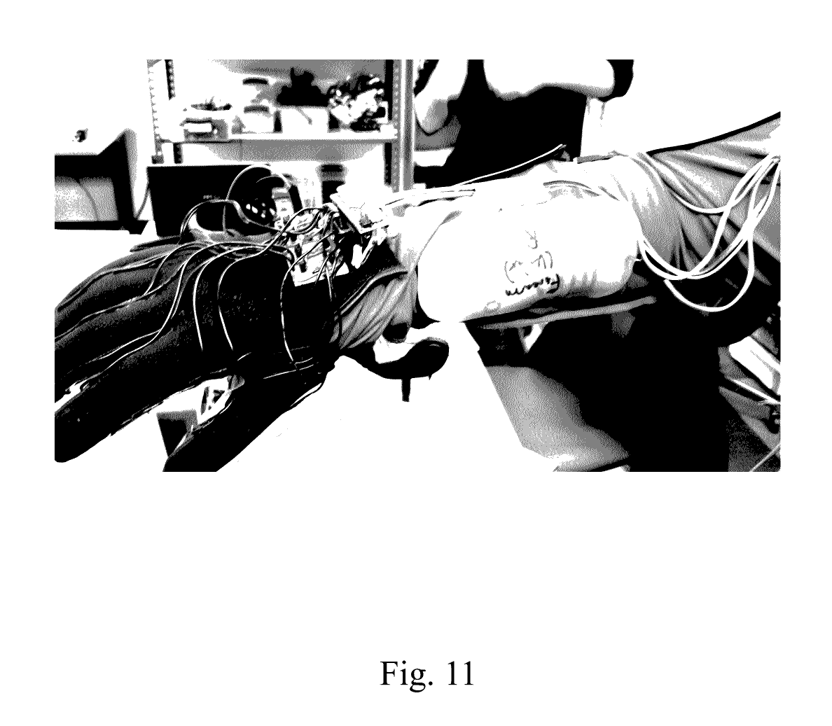

Motor control on the suit and in the hands as shown in FIGS. 9-11 is managed almost entirely through use of the TI DRV2604L haptic motor driver (an exception is the left hand, which. The DRV2604L driver provides extended haptic capability, including advanced braking and integrated ERM and LRA support, and are both configured and controlled through an I2C network.

However, limitations to the chip do not allow individual DRV chips to be given individual I2C addresses, instead relying on a universal slave address for the entire chip line. This restricts individual control of the DRV chips to commands via the Trigger line, which is handled via the PWM IO of a local microcontroller on the body. PWM control allows for variable intensity of attached motors and rapid braking to prevent unwanted lingering vibration after a zone has been commanded to stop. This level of control is sufficient for all current features, and can be expanded in the future through the use of I2C switching chips.

It should be noted that DRV2604L chips contain only nonvolatile memory and require an I2C-implemented initialization phase on power up, which necessitates bus connections despite the lack of a. This phase is conducted by the master controller every time the suit is powered on, and does not interfere with regular slave addressing during operation.

Slave operations such as those at the hands are conducted through the ARDUINO MICRO. To initialize an action commanded by the computer, the master node determines which slave node is associated with the given cluster and initiates an I2C packet session with that slave address. Zone and on/off information is then sent to that slave, where it is passed to the motor control via on board PWM output pins. This control allows individual motors to be set on and off at any slave on the body. Note that due to the speed of I2C, changing many motors sequentially takes only fractions of a second and is not distinguishable from simultaneous change within human reaction times.

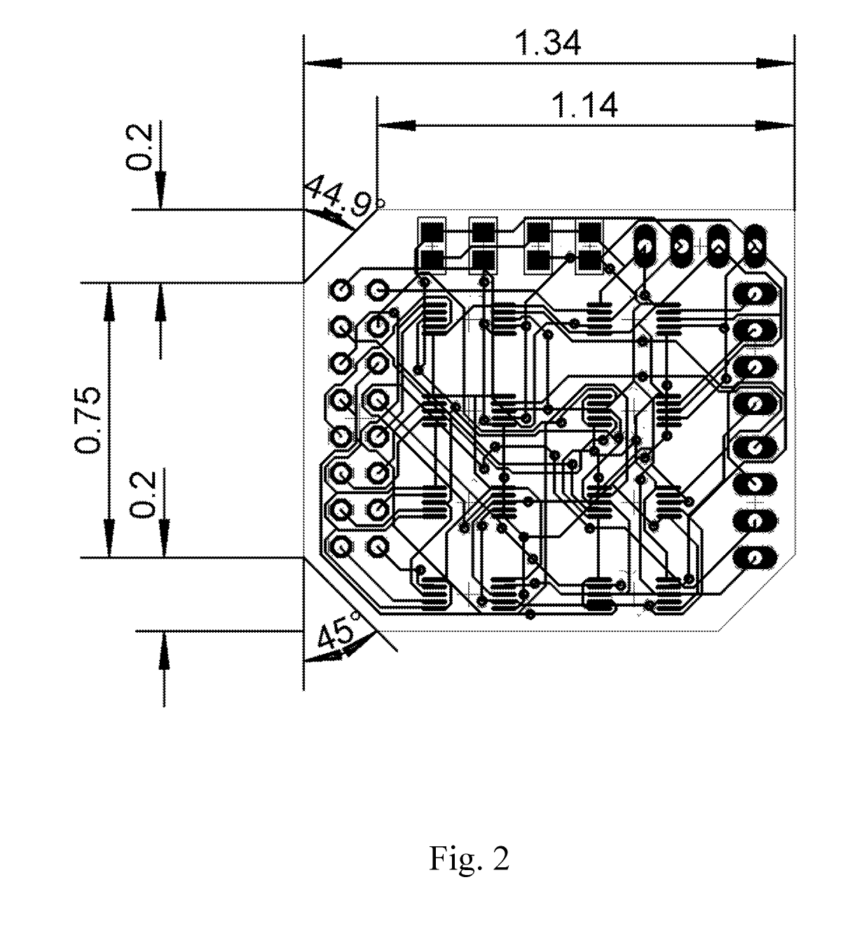

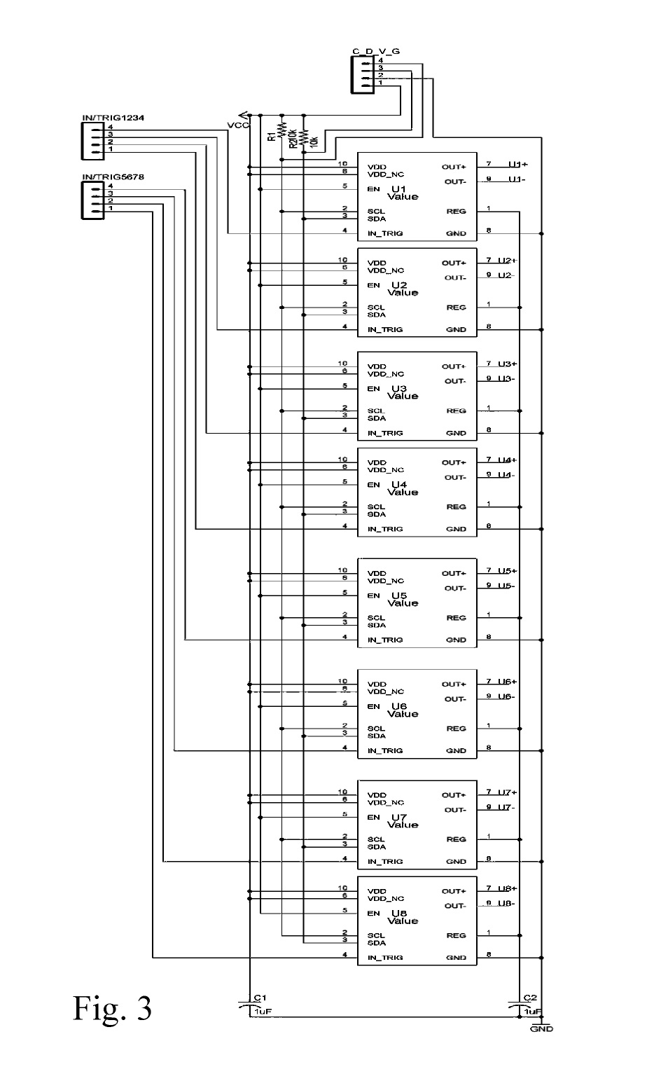

FIGS. 2-3 and 10-11 illustrate the PCB assembly used at the hands. Note that the Arduino Micro is not included in this diagram and is connected through the TRIG pin array: Note the inclusion of debouncing capacitors at power and ground, a capacitor at the output of the onboard DRV voltage regulator (not used) and the pullup resistors on the SDA and SCL lines of the I2C network interface.

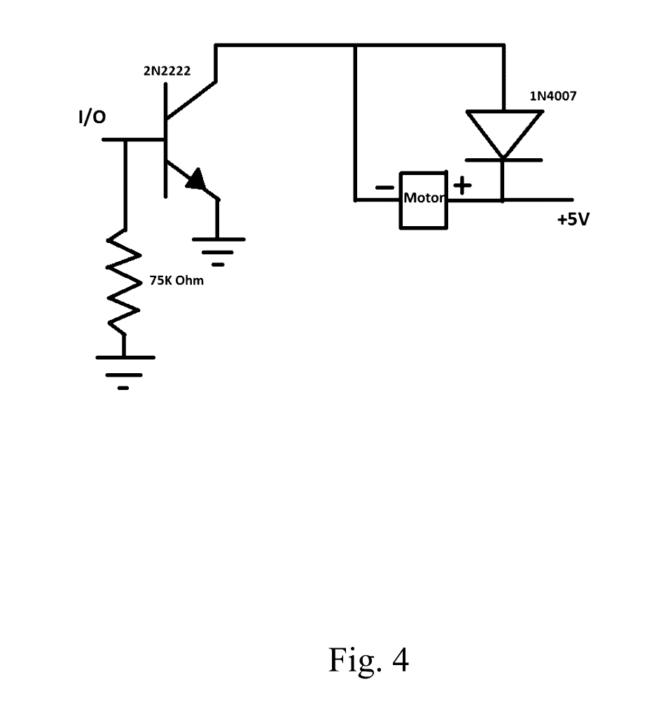

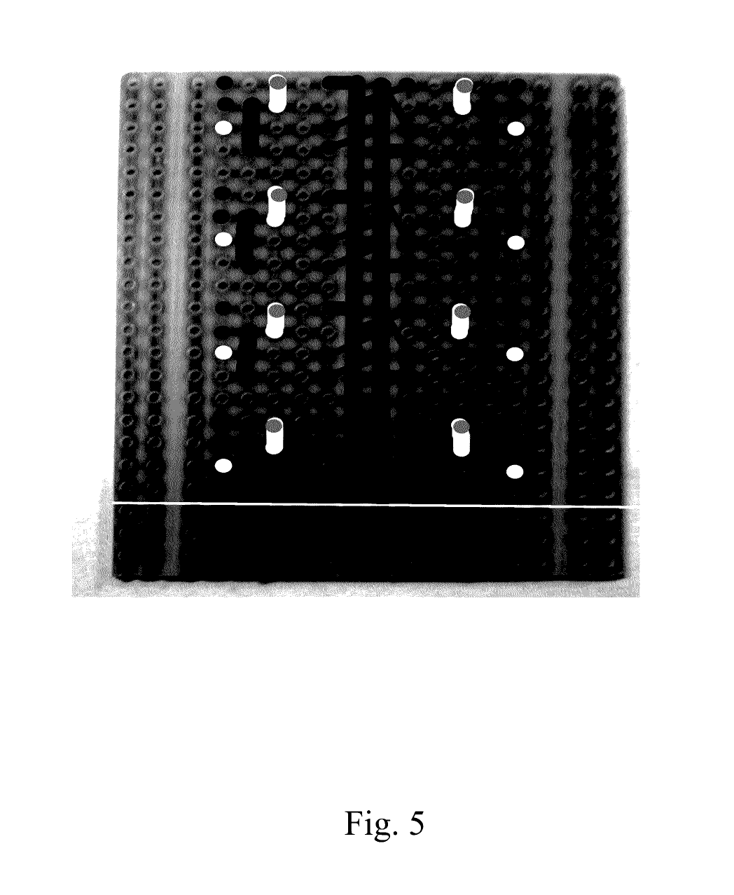

While it is still controlled by an ARDUINO MICRO I2C slave node, the motor driver hardware of the current prototype's left hand is a remnant of an earlier iteration of driver technology. This system is driven by hand assembled BJT unidirectional motor drivers, and as such lacks the braking operations available on the DRV chip. However, this driver does not require an initialization phase or I2C network connection to function and is generally more accessible for debugging purposes. The schematics used for this driver system are illustrated in FIGS. 4-5, following standard designs for discrete-component motor drivers.

Motors and electronics mounted on the suit are protected via 3D printed casings. All casing material is extrusion-grade PLA plastic; a hard, biodegradable, and aesthetically pleasing fiber type common for low size objects that do not require resistance to temperature variation. ABS fiber was considered but rejected due to lower quality prints.

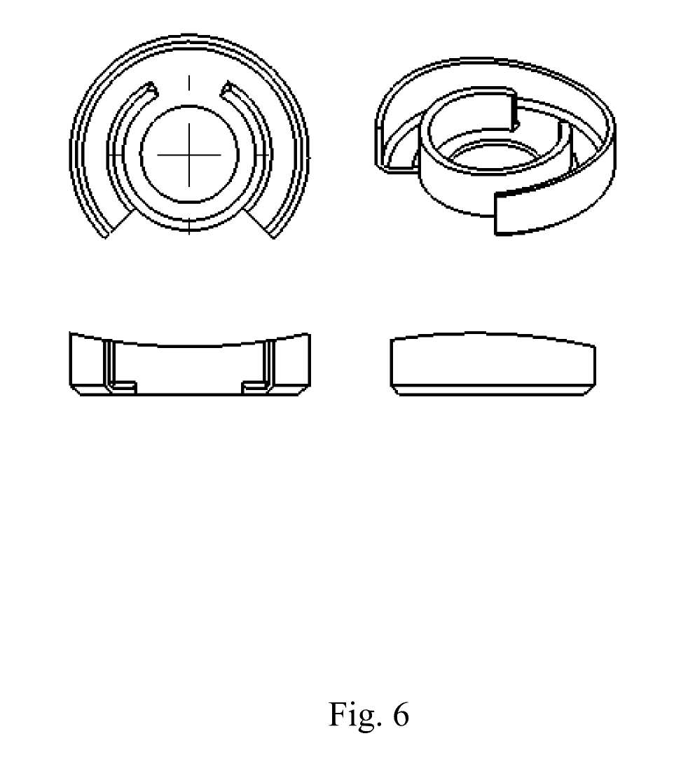

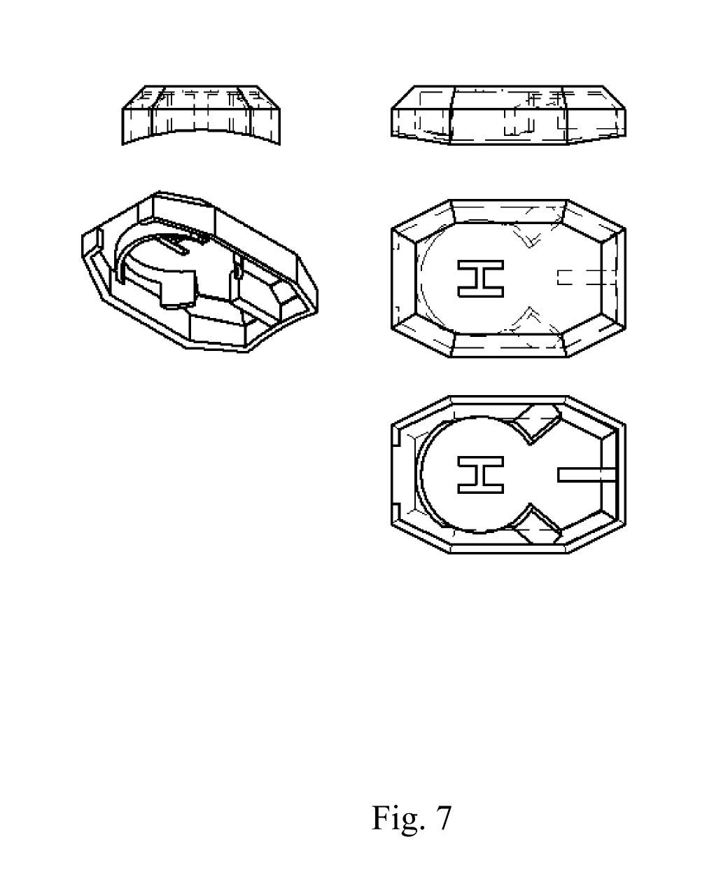

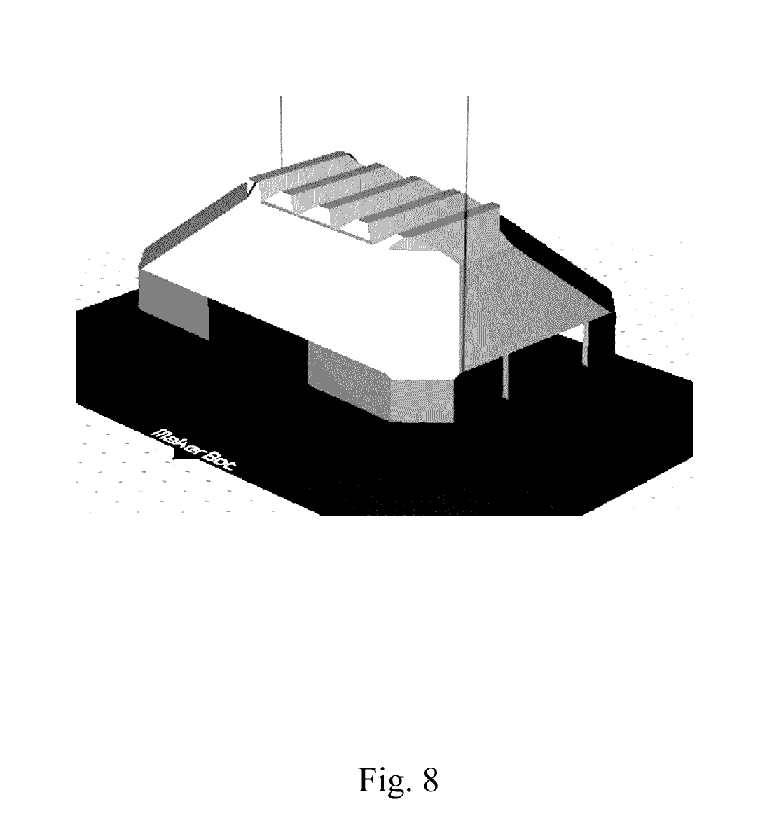

Casings were designed to provide the most minimal profile possible while still protecting the delicate terminal wiring connecting the motor to the PWM pin output cables of the ARDUINO slave node. After being printed and assembled, motor casings were infilled with silicone to add further durability to these vulnerable connections. These casings could then be adhered to either the rubberized surface of the suit's hands, or the vinyl infills of the zones inserted around the body. FIGS. 6-8 are images of the 3D designs used the motor casings and back electronics casing. Casings can be made from many materials and are not limited to just those disclosed in this application as being sufficient or compatible with the rest of the components.

The DE2i-150 FPGA development kit combines the Intel Atom Processor (N2600) with an Altera Cyclone IV FPGA. The development kit provides high processing power and configurability. High speed communication is paramount to the system of the present invention; any sort of latency would cause a disconnect between the visual input and kinematic sensation. The INTEL ATOM board provides a strong platform for hardware and software integration, since some of the complex calculations can be performed on the device.

Most of the calculations involved in the forward and reverse kinematics model require a powerful computer or microprocessor. From experiments in the initial stages, common processors such as the ARDUINO UNO and MEGA could not handle some of the iterative computational updates in obtaining quaternion and Euler angle data in order to input into the model to retrieve calibrated position and orientation data. The INTEL ATOM board could easily perform the calculations needed; however, the system was optimized by using simpler estimations. Most of the real time algorithms are implemented within the UNITY program. Despite this, the INTEL ATOM board can still be used to evaluate performance and act as a platform for hardware-software integration.

The system is set to run on a computing device or mobile electronic device. A computing device or mobile electronic device on which the present invention can run would be comprised of a CPU, Hard Disk Drive, Keyboard, Monitor, CPU Main Memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A system for full motion capture and haptic feedback using hardware components and software recorded on non-transitory computer-readable medium and capable of execution by a computer, said system device comprising:
One or two gloves comprised of sensors for detecting motion and orientation and each glove equipped with one or more electric motors for generating haptic feedback to a user wearing the gloves;
a 3D tracking system or a hybrid state using 9-axis sensors to move freely outside the view of the a 3D tracking system;
an integrated sensor network to detect the user's position in a space;
tracking a user's movements;
translating a user's movements into a virtual space; and
providing haptic feedback when the user comes into contact with a virtual object.

2. The device of claim 1, used in combination with a headset such as the OCULUS RIFT.

3. The device of claim 2, further comprising sending touch feedback to a custom-designed feedback suit based on virtual interactions

4. The device of claim 1, further comprising providing A software development kit is also being created for hybrid motion tracking, feedback management, and application development for use by independent content creators.

5. The device of claim 1, further comprising
a full-body suit embedded with vibrating motors and sensors;
said vibrating motors and sensors allowing users to “feel” virtual objects that have been projected around them by triggering specific feedback pads placed on the body.

6. The device of claim 1, further comprising a larger cloth-free exoskeleton embodiment intended for applications where sanitation and a one-size-fits-all design are desirable.

7. The device of claim 1, wherein the gloves and suit are further comprised of any combination of gyroscope, acclerometer, and magnetometer-based tracking sensors capable of compensating for camera obstructions and out of range motion, allowing for a seamless tracking experience on the part of the user.

8. The device of claim 1, further comprising a high-speed serial protocol networks as data links between parts of the body

9. The device of claim 1, further comprising an integration algorithm that combines data from the 3D tracking system with data from an on-suit gyro-accelerometer sensor network, the system provides a consistent high-resolution tracking solution complete with occlusion compensation and an expansive range.

10. The device of claim 1, wherein
the VR feedback hardware consists of a plurality of feedback zones,
each capable of individual analog control, providing various levels of clicks, hums, buzzes, and other sensations,
spaced out over the entire upper body.

11. The device of claim 1, wherein the system of the present invention relies on two computer systems: the ARDUINO system and the UNITY PC game engine.

12. The device of claim 1, wherein the system
reduces latency below perceptible levels;
increases both tracking and feedback resolution; and
provides compensation for occlusion and other tracking errors.

13. The device of claim 1, wherein
the software breaks down the sensors into clusters and haptic zones, where a cluster is a group of zones;
the upper body is a cluster, as is the lower body and each of the two hands;
clusters are logical groupings as well as hardware-limited groupings: currently only eight clusters can exist, each containing up to sixteen zones.

14. The device of claim 13, wherein each zone could be one motor or many within one pad: in the hands, each zone is one motor on each fingertip.

15. The device of claim 13, wherein
on the chest, each zone is multiple motors,
the highest resolution that a motor can be addressed by is its zone.

16. The device of claim 13, wherein haptic events are queued up with time delays.

17. The device of claim 1, wherein
the state of the entire haptic device is stored in a Boolean array;
commands affect this array so commands like toggle work properly.

18. The device of claim 15, wherein
a Master Controller provides commands that are sent from the host computer are interpreted by an on-body master controller system, which parses the information into on-chip memory and interprets the destination for the in-suit integrated network;
once the serial byte has been masked into different integers referencing cluster, zone, and status, they are run through a case statement that determines the task of the master system.

19. The device of claim 18, wherein
information is distributed through the suit via a combination of direct Pulse-Width-Modulation (PWM) control to the motor drivers, and a single-bus serial protocol network with a master-slave addressing system;
clusters one and two, representing the body, are implemented directly through master IO, as described in the Hardware IO section; and
sections three and four, representing the hands, are handled through the serial protocol bus.

20. The device of claim 1, wherein
motors and electronics mounted on the suit are protected via 3D printed casings;
all casing material is extrusion-grade PLA plastic; a hard, biodegradable, and aesthetically pleasing fiber type common for low size objects that do not require resistance to temperature variation;
casings were designed to provide the most minimal profile possible while still protecting the delicate terminal wiring connecting the motor to the PWM pin output cables of the ARDUINO slave node;
after being printed and assembled, motor casings were infilled with silicone to add further durability to these vulnerable connections;
these casings could then be adhered to either the rubberized surface of the suit's hands, or the vinyl infills of the zones inserted around the body.
